(19) United States
(12) Patent Application Publication
(10) Pub. No.: US 2007/0215418 A1
(43) Pub. Date: Sep. 20, 2007

(54) Brake Disk, Especially for a Rail Vehicle

(76) Inventors: Xaver Wirth, Ismaning (DE); Christian Mosbach, Germering (DE)

Correspondence Address: BARNES & THORNBURG LLP, 750-17TH STREET NW, SUITE 900, WASHINGTON, DC, 20006-4675, US

(21) Appl. No.: 10/578,319

(22) PCT Filed: Oct. 29, 2004
(86) PCT No.: PCT/EP04/12287

§ 371 Date: Feb. 5, 2007

(30) Foreign Application Priority Data
Nov. 5, 2003 (DE) 103 51 592.5

(51) Int. Cl. F16D 65/12

(52) U.S. Cl. 188/218 XL

(57) ABSTRACT

A brake disk for a rail vehicle includes a hub and at least one friction ring having radial grooves. The friction disk is fastened by a clamping bolt to the hub. Also included are sliding elements having a shank and the sliding elements are connected to the hub. The sliding elements engage in the radial grooves for anti-rotation locking and centering of the at least one friction ring. The sliding elements extend parallel to an axis of the clamping bolt.

### BACKGROUND AND SUMMARY

The present disclosure relates to a brake disk for a rail vehicle. The brake disk includes at least one friction ring which is provided with radial grooves and is fastened by clamping bolts to a hub, which can be secured to a shaft or a wheel disk. Sliding elements are connected to the hub or the wheel disk and engage in the radial grooves for anti-rotation locking and centering of the friction ring.

Such brake disks, which are used as “axle-mounted or wheel-mounted brake disks”, are subjected during operation to considerable mechanical and thermal stresses, which require special design measures in order to firstly ensure the requisite safety and secondly permit reasonably practicable assembly and dismantling for exchange purposes.

Since the friction rings expand due to the heating which occurs during the braking, simple centering by cylindrical seating on the hubs of axle-mounted brake disks, in particular in the case of two-piece high-performance brake disks, does not suffice. It is therefore known to fasten sliding elements in the form of sliding blocks to the hub. These sliding elements are guided in radial grooves of the respective friction ring, so that the friction ring can certainly expand radially, but the centering is retained by the lateral fixing of the sliding block in the radial groove. This equally applies to wheel-mounted brake disks, in which the friction rings are held on both sides of a wheel disk in a centered and rotationally locked manner.

The sliding blocks therefore prevent a radial displacement of the respective friction ring from occurring due to the applied braking torque or due to dynamic shocks, thereby possibly resulting inunacceptable unbalance.

In addition, friction rings made of ductile materials, for example steel, may shrink during operation due to plasticization processes in the friction surfaces, caused by high braking power and high temperatures. In this case, the friction rings, for exchange, can no longer be released from the hub without any problems.

The sliding blocks are also used in order to prevent this, so that the friction rings, as mentioned, can expand or shrink concentrically, the cylindrical play between the friction disk and the hub being designed to be correspondingly large for this purpose.

The use of such sliding blocks in wheel-mounted brake disks is known, for example, from EP 0 683 331 B1, EP 0 589 408 B1, EP 0 644 349 B1, DE 197 27 333 C2 and DE 100 47 980 C2.

The solution to the problems described of sliding blocks has proved successful in principle. However, the realization of these connections is only possible at a relatively high production cost, which precludes optimized manufacture from the cost point of view.

Furthermore, only a very small number of sliding blocks are used, normally three to six, which are dimensioned to be correspondingly large on account of the requisite load absorption and therefore take up a large amount of space. An additional drawback is non-uniform load transmission together with the resulting stresses due to the known arrangement and design of the sliding blocks.

The conventional dimensioning of the width of the sliding blocks (about 15-60 mm) leads to an increase in play of the sliding guide, that is of the radial grooves, due to the temperature differences which occur during operation of the brake disk. This temperature difference between radial groove and sliding block may amount to several hundred degrees C. in friction rings. For example, a groove width b_{N}=20 mm and a temperature difference ΔT=200 K may be assumed. Thus:
Δb=b·αₜₕ·ΔT20·10⁻⁵·200 K=0.04 mm

This value appears to be small, but in the case of friction ring masses of about 100 kg (average size) means unbalance of U=m·e=4 gm (e=eccentricity). This value already amounts to more than half the acceptable unbalance in the case of high-performance brake disks.

As already mentioned, it is very costly to make the radial grooves and the sliding blocks, especially by the requisite machining.

The present disclosure relates to a brake disk such that its operability is improved and more cost-effective manufacture is made possible.

The present disclosure relates to a brake disk for a rail vehicle. The brake disk includes a hub and at least one friction ring having radial grooves and fastened by a clamping bolt to the hub. The sliding elements include a shank and are connected to the hub. The sliding elements engage in the radial grooves for anti-rotation locking and centering of the at least one friction ring. The sliding elements extend parallel to an axis of the clamping bolt.

The present disclosure permits, instead of a few sliding element guides, a larger number of “miniature sliding element guides” which prevent, for example, problems described with reference to the prior art with regard to different expansions of the sliding elements and of the radial grooves, and consequences arising therefrom. The present disclosure offers a noticeable improvement in operating safety, since no appreciable unbalance is produced.

A manufacture of the brake disk, according to the present disclosure, also becomes simpler and more cost-effective. When the sliding elements are produced, for example, machined from a semi-finished product or a standard part, this can be done with little outlay. This equally applies to the incorporation of the radial grooves in the friction ring, it being possible for said radial grooves to be produced with very little outlay.

According to the present disclosure, provision is made for a radial groove and an engaging guide pin to be assigned to each clamping bolt, with which the friction ring is fastened to the hub. A respective radial groove, starting from a through-hole for passing the through-bolt through, is extended outward or inward toward the center longitudinal axis of the hub. Incorporation of the radial groove in this region is especially simple.

Due to the small dimensions of the guide pins forming the sliding elements, in particular with regard to the cross-sectional dimensions, and an accompanying reduction in play during heating between the guide pin and the radial groove, an improved centering effect is achieved.

The play mentioned with respect to the prior art and caused by temperature differences is, for example, 0.04 mm at a groove width of 20 mm. The play, in accordance with the present disclosure and with a guide pin inserted and at a width of the radial groove of 5-10 mm, is reduced to 0.01-0.02 mm. Thus, a quality of the centering is more than doubled.

The guide pins are inserted into holes of the hub in the case of an axle-mounted brake disk or into holes of the wheel disk in the case of a wheel-mounted brake disk. The holes are kept correspondingly small, so that, despite the larger number, the weakening of the material is slight and the strength of the component is increased. This is especially important in the case of brake disks in which the locating holes are incorporated directly on the wheel web.

A larger number of sliding elements forms a form fit and permits in interaction with the radial grooves a more uniform transmission of the braking torque from the friction ring to the hub or the wheel disk. A larger number of friction ring connections also permits the transmission of a higher braking torque, the number of guide pins depending on the proportion of braking torque which is to be transmitted by a form fit.

The arrangement of the guide pins is to be selected according to the number of connecting lugs of the friction ring or of the screwed or bolted connections. The guide pins are distributed symmetrically, for example, 3, 6, 9, or 12 guide pins are distributed over the circumference of the hub.

A form fit between the sliding elements and the radial grooves which can be subjected to high dynamic loading is obtained when the sliding elements, or the guide pins, are of planar design in the region bearing against the side wall of the radial grooves. Contact seating of the friction ring on the hub can thus be dispensed with, with the effect that removal without any problems is possible even in the case of a shrunken friction ring.

Due to the high redundancy which results from the relatively large number of form-fit connections, increased safety of the form fit overall is ensured. That turns out to be an advantage in the event of a possible incorrect assembly.

The small space required for accommodating the sliding elements on the one hand, and for incorporating the radial grooves on the other hand, permits the use of these form-fit connections in virtually all types of disk construction.

Other aspects of the present disclosure will become apparent from the following descriptions when considered in conjunction with the accompanying drawings.

### BRIEF DESCRIPTION OF THE DRAWINGS

FIG. 1 shows a partial cross-section view of a brake disk, according to the present disclosure.

FIG. 2 shows a cross-section view along line II-II in FIG. 1.

FIG. 3 shows a partial cross-section view of another embodiment of a brake disk according to the present disclosure.

FIG. 4 shows a cross-section view along line IV-IV in FIG. 3.

FIG. 5 shows a view, similar to FIG. 2, of another embodiment of a brake disk, according to the present disclosure.

FIG. 6 shows a view, similar to FIG. 2, of another embodiment of a brake disk, according to the present disclosure.

FIGS. 7a)-7d) show illustrative shapes and configurations of sliding elements, according to the present disclosure.

### DETAILED DESCRIPTION

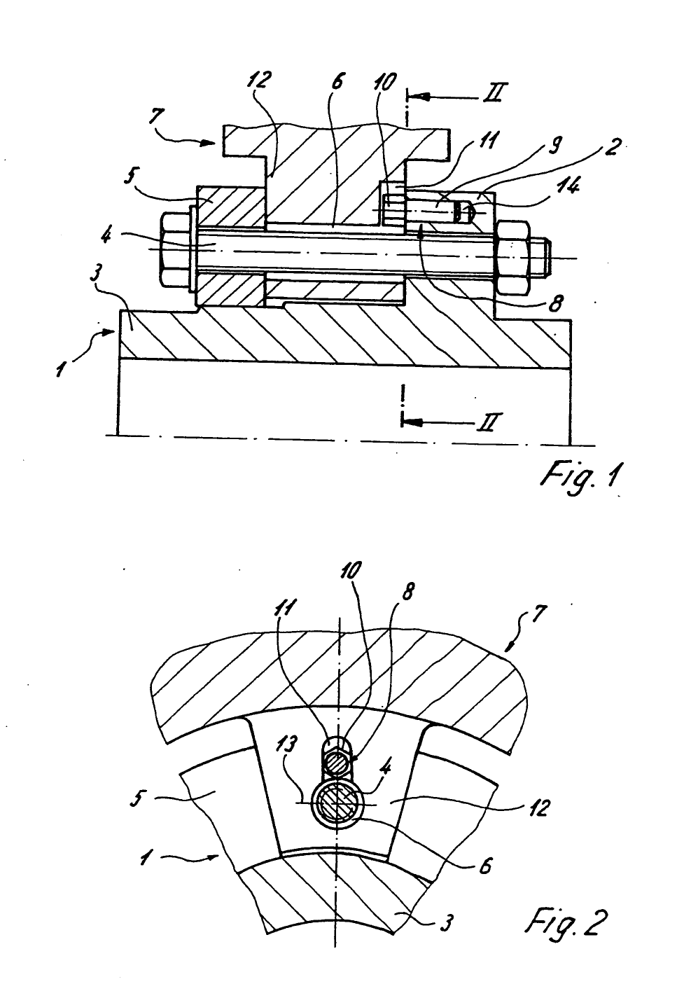

Shown in FIGS. 1 to 6 are illustrative embodiments of an axle-mounted brake disk, which embodiments include a hub 1 having an axially extending hub body 3 and an encircling hub flange 2 extending radially thereto. Also included is at least one friction ring 7 which is fastened to the hub 1 by clamping bolts 4.

The clamping bolts 4 are passed through a clamping ring 5 arranged opposite the hub flange 2, through a connecting lug or flange 12 assigned to each clamping bolt 4 of the friction ring 7 and through the hub flange 2. The connecting flange 12 includes a through-hole 6 for passing the clamping bolt 4 through and clamping the clamping bolt 4 in place between the clamping ring 5 and the hub flange 2.

A radial groove 11 is provided in the connecting flange 12 in the region of each through-hole 6. Radial groove 11, as shown in FIG. 1, extends outward toward a center longitudinal axis of the hub starting from the through-hole 6 relative to a pitch circle diameter 13, and on which the clamping bolts 4 or the through-holes 6 are arranged in a symmetrically distributed manner.

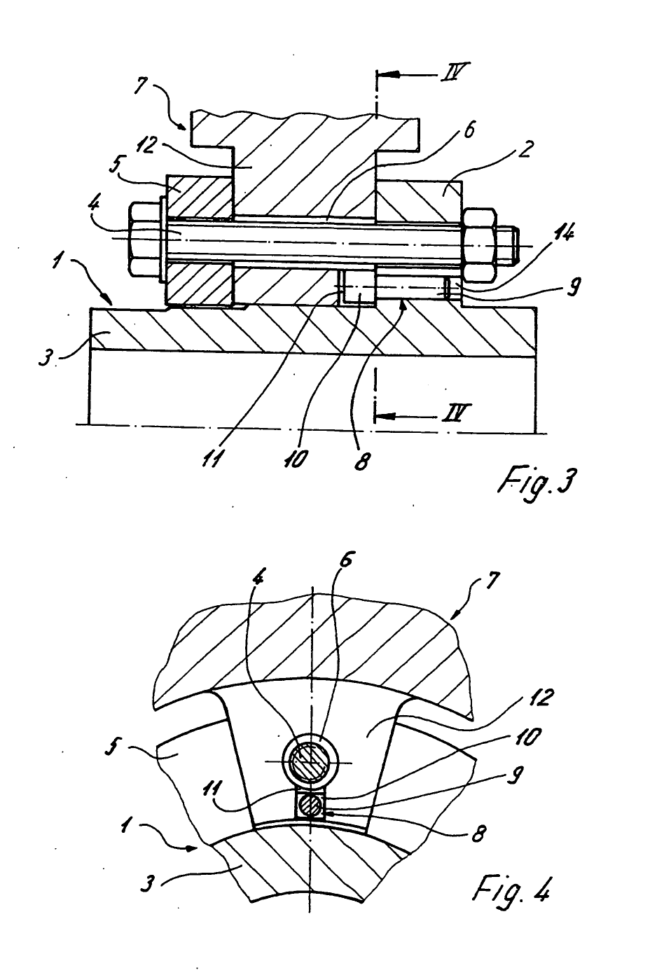

In illustrative embodiments according to FIGS. 3 and 4, a respective radial groove 11, starting from the through-hole 6, extends inward toward the center longitudinal axis of the hub 1.

Guided in the radial groove 11 is a sliding element 8 in the form of a guide pin which, with its shank 9, rests in an axially secured manner parallel to the longitudinal axis of the clamping bolt 4 in an insertion hole 14 of the hub flange 2.

Integrally formed on a free end of sliding element 8 is a head 10, which in cross section may have the shape of a polygon, such as a square or hexagon, and has at least two opposite parallel sides which bear against associated side walls of the radial groove 11.

A thermally induced radial expansion of the friction disk 7 is possible because the through-hole 6 of the connecting flange 12 is oversized relative to the shank 9 of the clamping bolt 4, so that there is also sufficient play. On account of the engagement of the sliding elements 8 in the radial grooves 11, a centering of the friction disk 7 is always ensured.

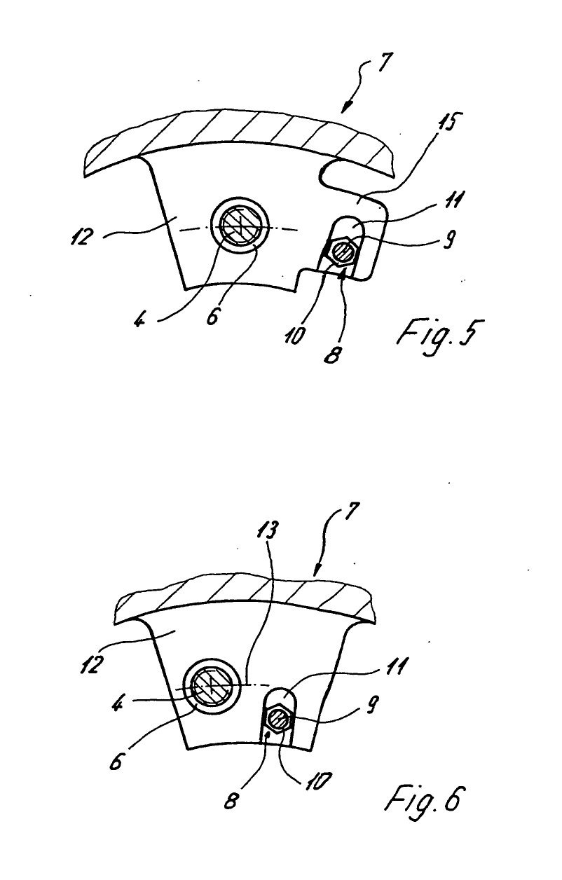

As shown in each of the illustrative embodiments of FIGS. 5 and 6, the radial groove 11 is arranged outside the through-hole 6, starting from a side facing the hub 1. The radial groove 11, in the illustrative embodiment according to FIG. 5, is incorporated in a lug 15 which is integrally formed laterally on the connecting flange 12, ends at a distance from the hub 1 and permits a simple fitting of the sliding element 8.

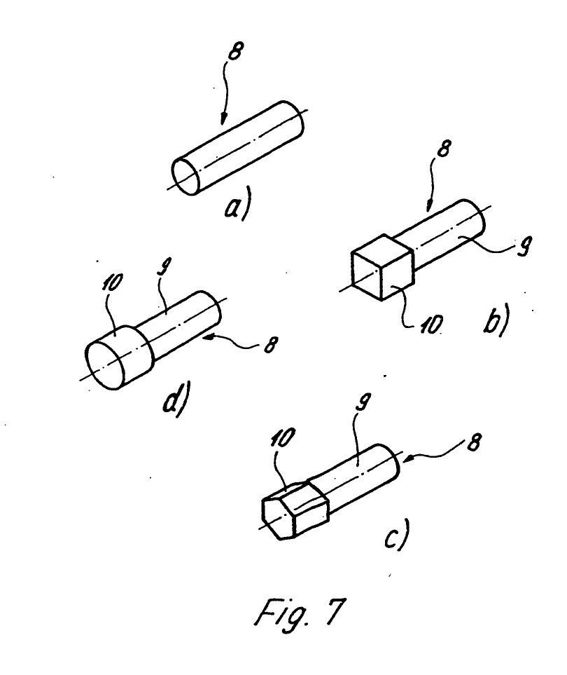

Illustrative embodiments of sliding elements 8 as guide pins are shown in FIGS. 7a)-d).

Shown in FIG. 7a) is a sliding element as a straight pin. A standard part, for example, may be used for this purpose. Shown in FIG. 7b) is an embodiment of a sliding element 8 that corresponds to the illustrative embodiment shown in FIGS. 3 and 4, having a square head 10 adjoining a cylindrical shank 9 and resting in radial groove 11 of the friction ring or disk 7.

Shown in FIG. 7c) is a sliding element in which the head 10 resting in the radial groove 11 has a cross-section of a hexagon. Shown in FIG. 7d) is a sliding element including a head 10 having a cross-section of a cylinder, as does shank 9.

The sliding elements shown in FIGS. 7b)-d) may be produced from a semi-finished product, for example from a square, hexagonal or round steel bar, on which a cylindrical shank 9 is turned.

It is also possible to use other suitable standard parts or semi-finished products that can be correspondingly machined.

Although the present disclosure has been described and illustrated in detail, it is to be clearly understood that this is done by way of illustration and example only and is not to be taken by way of limitation. The scope of the present disclosure is to be limited only by the terms of the appended claims.

1. A brake disk for a rail vehicle, the brake disk comprising:
a hub;
at least one friction ring having radial grooves and fastened by a clamping bolt to the hub;
sliding elements having a shank and being connected to the hub, the sliding elements engaging in the radial grooves for anti-rotation locking and centering of the at least one friction ring, and the sliding elements extending parallel to an axis of the clamping bolt.

2. The brake disk as claimed in claim 1, wherein each radial groove, starting from a through-hole of the friction ring and through which through-hole the clamping bolt passes, is extended outward toward a center longitudinal axis of the hub.

3. The brake disk as claimed in claim 1, wherein each sliding element is arranged in an insertion hole of the hub.

4. The brake disk as claimed in claim 1, wherein each sliding element includes a head which is guided in an associated radial groove.

5. The brake disk as claimed in claim 1, wherein each radial groove has a width of 10 mm.

6. The brake disk as claimed in claim 1, wherein each sliding element is a straight pin.

7. The brake disk as claimed in claim 1, wherein a head of each sliding element has a cross-section of a square.

8. The brake disk as claimed in claim 1, wherein a head of each sliding element includes two sides which run parallel to one another and bear against side walls of an associated radial groove.

9. The brake disk as claimed in claim 1, wherein each sliding element includes a polygonal-shaped head and a cylindrical shank integrally formed with the polygonal-shaped head by machining.

10. The brake disk as claimed in claim 1, wherein the sliding elements are arranged in a symmetrically distributed manner over a circumference of the hub.

11. The brake disk as claimed in claim 1, wherein one of 3, 6, 9 and 12 sliding elements are provided.

12. The brake disk as claimed in claim 1, wherein at least seven sliding elements are provided.

13. The brake disk as claimed in claim 1, wherein the number of sliding elements corresponds to the number of clamping bolts.

14. The brake disk as claimed in claim 1, wherein each sliding element is a guide pin.

15. The brake disk as claimed in claim 1, wherein each radial groove, starting from a through-hole of the friction ring and through which through-hole the clamping bolt passes, is extended inward toward a center longitudinal axis of the hub.

16. The brake disk as claimed in claim 1, wherein each sliding element is arranged in an insertion hole of a hub flange.

17. The brake disk as claimed in claim 1, wherein a head of each sliding element has a cross-section of a hexagon.

18. The brake disk as claimed in claim 1, wherein a head of each sliding element has a cross-section of a polygon.

19. The brake disk as claimed in claim 9, wherein the polygonal-shaped head is produced from polygonal steel.
